(19) United States
(12) Patent Application Publication
(10) Pub. No.: US 2007/0099459 A1
(43) Pub. Date: May 3, 2007

(54) FAN

(75) Inventors: Takaya OTSUKI, Minami-ku, Kyoto (JP); Takahiro KIKUICHI, Minami-ku, Kyoto (JP); Masayuki YAMADA, Minami-ku, Kyoto (JP); Toshikazu FUKUNAGA, Minami-ku, Kyoto, JP (JP); Katsuo TAZAWA, Minami-ku, Kyoto (JP); Atsuo KONISHI, Minami-ku, Kyoto (JP); Mitsunobu NAKASE, Minami-ku, Kyoto (JP); Yusuke YOSHIDA, Minami-ku, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Minami-ku (JP)

(21) Appl. No.: 11/554,087

(22) Filed: Oct. 30, 2006

(30) Foreign Application Priority Data
Oct. 28, 2005 (JP) 2005-313623

(51) Int. Cl. H01R 13/44

(52) U.S. Cl. 439/144

(57) ABSTRACT

A fan includes a motor, an impeller mounted to the motor and generating air flow by rotation around a rotation axis thereof, and a housing defining a passage of the air flow and supporting the motor. A wire outlet opening is provided on the housing in a manner axially penetrating the housing, and a lead wire is inserted into the wire outlet opening. A lead wire holding member is inserted into the wire outlet opening into which the lead wire is inserted, the lead wire holding member elastically presses the lead wire to the housing, and a latching portion of the lead wire holding member is latched to a portion of the housing. Therefore, the lead wire holding member fits in the wire outlet opening while firmly holding the lead wire in the wire outlet opening.

### BACKGROUND OF THE INVENTION

1. Field of the Invention

The present invention generally relates to a fan, more particularly relates to a fan having a structure firmly holding a lead wire.

2. Description of the Related Art

Recently, fans are used for various applications. For example, an electronic device may have a cooling fan to radiate heat to an outside of the casing of the electronic device. A copying machine includes a suction fan to feed papers.

Generally, the fan is defined by a motor which includes a rotor and a stator, an impeller which includes a plurality of blades arranged around the rotor, and a housing which supports the stator and radially surrounds the impeller. The fan also includes lead wires to supply electricity thereto, and the wires extend from a circuit board which is installed in the fan to an outside of the housing.

Conventionally, the wires are housed and extend within a lead wire guiding groove provided on the housing, and the wires are hooked to a portion of the housing before leading out from the housing of the fan. In the conventional fan, the wires are not firmly held on the housing and therefore, the wires may go slack and be lifted from an end surface of the housing when an external force is applied thereto. In installing the fan, the slack wire may get caught with other electronic components, which may result in damaging the other electronic components and/or breaking the wire. Recently, dimensions of the electronic devices are getting smaller and smaller. Correspondingly, an available space to arrange electronic components and/or the fan is getting smaller and smaller. As a result, the fan is arranged near other electronic components, and it is getting more likely that the slack wire may damage other electronic components and/or itself. Therefore, the wire should be firmly held, otherwise the slack wire maybe an obstacle to installing the fan into the electronic device or may cause damage to the electronic device.

Conventionally, the wires are housed within the lead wire guiding groove, and a bushing member is attached thereto to hold the wires so that the wires do not protrude from the end surface of the housing.

In the conventional fan, the bushing member is attached to the wire guiding groove to create a gap between the bushing and an inner wall of the wire guiding groove narrower than the outer dimension of the wire so as to pinch the wire therebetween. In the configuration mentioned above, the gap dimension has to be carefully determined based on the wire dimension or the number of wires to be used to firmly hold the wires without damaging them. When the gap is too narrow in relation to the dimension of the wires, excessive pressure is applied to the wires and the wires may be broken or damaged. When the gap is too wide, the wire may be loosely held. Therefore, the design of the bushing member has to be changed relative to the numbers of wires and/or the dimensions of the wires housed within the wire guiding groove to maintain the appropriate gap between the bushing member and the inner wall of the groove. In this connection, the bushing member is preferably not applied to the products whose wire and/or the number of wires are standardized.

### SUMMARY OF THE INVENTION

In order to overcome the problems described above, preferred embodiments of the present invention provide a fan having a lead wire holding member which firmly holds the lead wire without damaging the wire regardless of the dimensions and numbers of lead wires.

A fan according to a preferred embodiment of the present invention includes a motor, an impeller mounted to the motor and generating air flow by rotation around a rotation axis thereof, and a housing defining a passage of the air flow and supporting the motor. The housing includes a wire outlet opening and a lead wire extends into the wire outlet opening from an upper end thereof and extends out of the wire outlet opening from a bottom end thereof. After the lead wire is inserted into the wire outlet opening, a lead wire holding member is inserted into the wire outlet opening. The lead wire holding member includes an abutting portion abutting against a portion of the housing near an upper end of the wire outlet opening, a plate portion protruding from the abutting portion and guiding the lead wires to the axially bottom direction, and a latching portion latched to a portion of the housing. With the abutting portion abutted against the portion of the housing and the latching portion latched to the housing, an axial movement of the lead wire holding member is restricted.

A fan according to the present preferred embodiment of the present invention includes a motor, an impeller mounted to the motor and generating air flow by rotation around a rotation axis thereof, and a housing defining a passage of the air flow and supporting the motor. The housing includes a wire outlet opening and a lead wire extending into the wire outlet opening from an upper end thereof and extending out of the wire outlet opening from a bottom end thereof. After the lead wire is inserted into the wire outlet opening, a lead wire holding member is inserted into the wire outlet opening. The lead wire holding member includes an abutting portion abutting against a portion of the housing near an upper end of the wire outlet opening, a plate portion protruding from the abutting portion and guiding the lead wires to the axially bottom direction, and a latching portion latched to a portion of the housing. With the abutting portion abutted against the portion of the housing and latching portion latched to the housing, an axial movement of the lead wire holding member is restricted.

According to another preferred embodiment of the present invention, the latching portion is latched to a portion of the housing defining a bottom end of the wire outlet opening. According to another preferred embodiment of the present invention, the latching portion includes two or more convexes or concaves, each of which extends in a direction different from others. Therefore, the lead wire holding member according to the preferred embodiments of the present invention does not easily come off of the wire outlet opening when an external force is applied to the lead wire holding member.

According to another preferred embodiment of the present invention, the plate portion inserted into the wire outlet opening faces to a portion of the housing defining an upper end of the wire outlet opening and makes contact with the lead wire. According to another preferred embodiment of the present invention, the lead wire is elastically pressed against the housing by the plate portion, and is pinched the plate portion and the portion of the housing defining the portion of the wire outlet opening. Therefore, according to the present preferred embodiment of the present invention, the lead wire is firmly held to the housing.

According to another preferred embodiment of the present invention, the fan further includes an opening extending radially from the wire outlet opening to the outside of the housing. Upon inserting the lead wire into the wire outlet opening, the lead wire is inserted into the wire outlet opening from the outside of the housing via the opening. Moreover, the plate portion of the lead wire holding member includes a protruding portion protruding radially outwardly therefrom and fit into the opening.

According to another preferred embodiment of the present invention, the housing further includes a through hole near the wire outlet opening, and the latching portion is latched to a portion of the housing defining a bottom end of the through hole.

According to another preferred embodiment of the present invention, the fan includes a step portion where the housing is axially concave. The step portion is arranged adjacent to the wire outlet opening, and the abutting portion is placed in the step portion without protruding axially upwardly from an upper end surface of the portion of the housing around the stepping portion.

According to another preferred embodiment of the present invention, the fan is preferably made of a molded plastic or resin.

According to another preferred embodiment of the present invention, the portion of the housing defining an upper end of the wire outlet opening and making contact with the lead wire preferably has a curved shape or a chamfered shape. Therefore, the lead wire pressed against the portion is not easily damaged or broken.

In the description of the preferred embodiments of the present invention herein, words such as upper, lower, left, right, upward, downward, top, and bottom for explaining positional relationships between respective members and directions merely indicate positional relationships and directions in the drawings. Such words do not indicate positional relationships and directions of the members mounted in an actual device.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 is a perspective view of a fan according to a first preferred embodiment of the present invention.

FIG. 2 is a perspective view of a fan according to the first preferred embodiment of the present invention with a wire holding member inserted into the fan.

FIG. 3 is a sectional view showing a wire holding portion of a fan according to the first preferred embodiment of the present invention.

FIG. 4 is a perspective view from the bottom direction of the fan according to the first preferred embodiment of the present invention.

FIG. 5 is a plan view of the fan according to the first preferred embodiment of the present invention.

FIG. 6A is a perspective view of a lead wire holding member according to the first preferred embodiment of the present invention.

FIG. 6B is a perspective view of a lead wire holding member according to the first preferred embodiment of the present invention.

FIG. 6C is a perspective view of a lead wire holding member according to the first preferred embodiment of the present invention.

FIG. 6D is a perspective view of a lead wire holding member according to the first preferred embodiment of the present invention.

FIG. 7A is a perspective view of the lead wire holding member according to another preferred embodiment of the present invention.

FIG. 7B is a perspective view of the lead wire holding member according to another preferred embodiment of the present invention.

FIG. 8 is a perspective view showing a wire outlet opening according to another preferred embodiment of the present invention in detail.

FIG. 9A is a perspective view of a lead wire holding member according to a second preferred embodiment of the present invention.

FIG. 9B is a perspective view of a lead wire holding member according to the second preferred embodiment of the present invention.

FIG. 10 is a perspective view showing a wire outlet opening according to the second preferred embodiment of the present invention.

FIG. 11 is a sectional view showing the wire outlet opening according to the second preferred embodiment of the present invention.

FIG. 12 is a sectional view showing the wire outlet opening according to the second preferred embodiment of the present invention in detail.

### DETAILED DESCRIPTION OF PREFERRED EMBODIMENTS

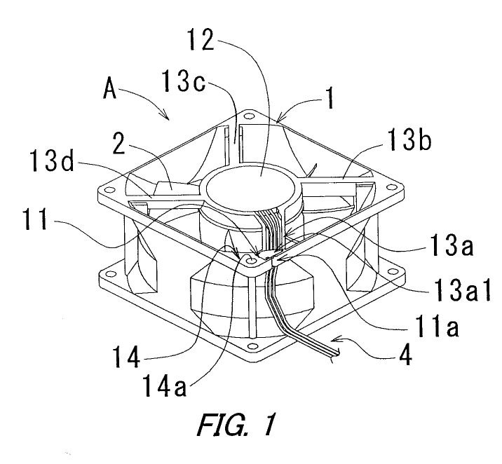

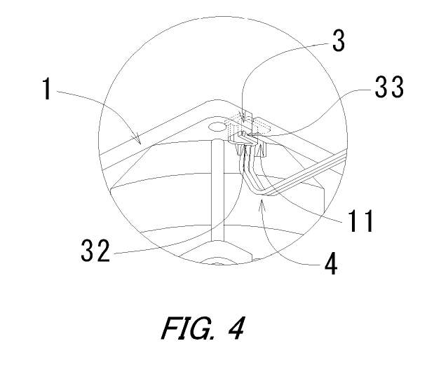

Referring to FIGS. 1 to 12, a fan according to preferred embodiments of the present invention will be described in detail. It should be understood that in the explanation of the present invention, when positional relationships among and orientations of the different components are described as being such as top/bottom, up/down or left/right, positional relationships and orientations that are in the drawings are indicated, and positional relationships among and orientations of the components once having been assembled into an actual device are not indicated. Meanwhile, in the following description, an axial direction indicates a direction parallel to a rotation axis, and a radial direction indicates a direction perpendicular to the rotation axis.

### First Preferred Embodiment

In the first preferred embodiment of the present invention, a fan A shown in FIG. 1 is defined by a motor which has a rotor and a stator, an impeller 2 which includes a plurality of blades arranged around the rotor, a housing 1 which supports the stator and radially surrounds the outer circumference of the impeller. The stator is arranged on a base 12, and the base 12 is connected to the housing via four ribs 13a, 13b, 13c, and 13d. The housing 1 radially surrounds the impeller 2 and defines a passage of air flow generated by the rotation of the impeller 2. An outer circumference of the housing 1 has a substantially square shape on its upper and bottom end portions. In addition, an outer circumference of the housing 1 at its middle portion has a substantially circular shape whose diameter is substantially the same as a side length of the square shape. Therefore, each of the upper and bottom ends includes flange portions protruding radially outwardly at the four corners. The flange portions include mounting holes 14a which are used to mount the fan A to an electronic device with screws, for example. The four ribs 13a, 13b, 13c, and 13d are arranged in an equally spaced manner in a circumferential direction.

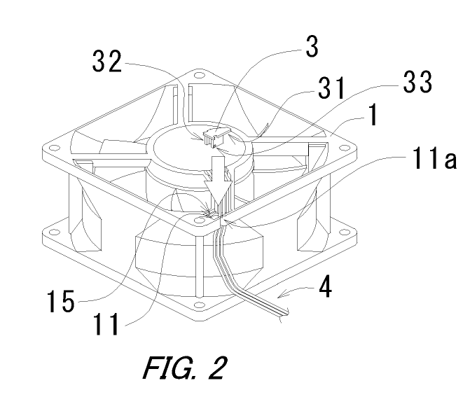

A circuit board (not shown in the drawings) is mounted on abase side of the stator, and a plurality of lead wires 4 are electrically connected to the circuit board. The lead wires 4 are accommodated in a lead wire guiding groove 13a1 provided on a rib 13a and extend to a wire outlet opening 11. The lead wire guiding groove 13a1 has enough depth to accommodate a plurality of lead wires 4, preferably four wires, without any of the lead wires 4 protruding from the end surface of the housing 1. By virtue of this configuration, the lead wires do not protrude from the end surface of the housing 1, and do not protrude toward the impeller 2. Therefore, the lead wires 4 do not contact with and/or get caught by the impeller 2 during the rotation thereof. As shown in FIG. 2, the rib 13a is connected to the housing 1 at a flange portion 14, and the flange portion 14 includes the wire outlet opening 11 axially penetrating the flange portion 14, from which the lead wires 4 extend out of the housing 1. Moreover, the wire outlet opening 11 includes an opening 11a extending radially outwardly and connecting to the outside of the housing 1. Upon inserting the lead wires 4 into the wire outlet opening, the lead wires 4 extend radially outwardly in the lead wire guiding groove 13a 1 and extend out of the housing. Then, via the opening 11a connecting the outside of the housing 1 and the wire outlet opening 11, the lead wires 4 are inserted into the wire outlet opening 11 from an upper to bottom direction(i.e., from an outside to an inside of the wire outlet opening) via the opening 11a. Without the opening 11a, tip ends of the lead wires 4 have to be inserted into the wire outlet opening 11. However, in this preferred embodiment of the present invention, the lead wires 4 may be easily inserted into the wire outlet opening 11 by inserting a middle of the lead wires 4 into the wire outlet opening 11 via the opening 11a. The width of the opening 11a is just about the size so that a thick lead wire (i.e., about 1.5 mm diameter) may barely pass through. By virtue of the configuration mentioned above, the lead wires 4 may be easily inserted into the wire outlet opening 11 but do not easily come out of the opening 11a. The lead wires 4 inserted into the wire outlet opening 11 then extend to the outside of the housing 1.

After the lead wires 4 are inserted into the wire outlet opening 11, a lead wire holding member 3 is inserted into the wire outlet opening. Upon the insertion of the lead wire holding member 3, the lead wires 4 are bent downwardly and are pressed against an edge 10 defined by the wire outlet opening 11 and the lead wire guiding groove 13a 1. If the edge 10 is defined in an angular manner, the lead wires 4 and/or covers thereof may be broken or damaged upon pressing the lead wires 4 against the edge 10. In this preferred embodiment of the present invention, however, the edge 10 has a curved shape. Therefore, the lead wires 4 and/or covers thereof are not easily damaged by contacting with the edge 10 when the lead wires 4 extend outside of the housing 1.

FIG. 1 shows the housing 1 in which the lead wire holding member 3 is inserted into the wire outlet opening 11. The lead wire holding member 3 is axially inserted into the wire outlet opening 11 as shown in FIG. 2. Without the lead wire holding member 3, the lead wires 4 may come out of the opening 11a or may go slack and protrude from the upper end surface of the housing 1 when an external force is applied to the lead wires 4. Such slack in the lead wires 4 may be an obstacle when installing the fan into the electronic device and/or may cause damage to the electronic components of the electronic device. In the present preferred embodiment of the present invention, however, the lead wire holding member 3 is inserted into the wire outlet opening 11 and the lead wires 4 are firmly held. Therefore, it is possible to prevent the above problem from occurring.

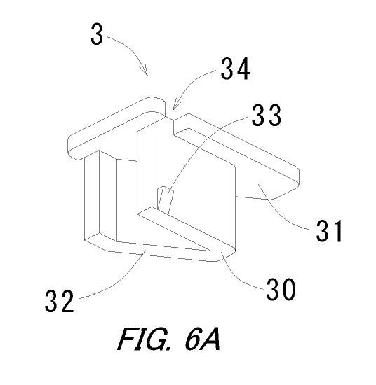

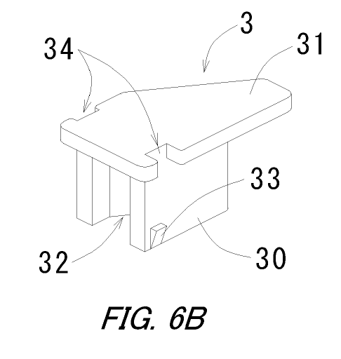

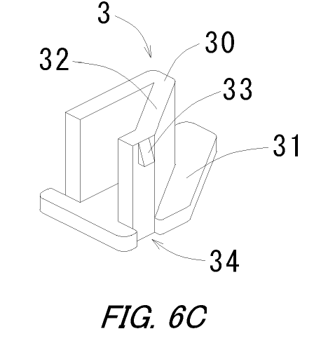

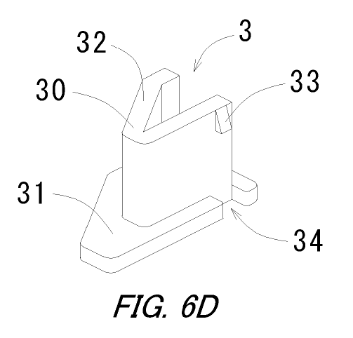

Next, the lead wire holding member 3 will be described in detail. FIGS. 6A to 6D are perspective views of the lead wire holding member 3 from different angles.

The lead wire holding member 3 is preferably made of plastic or resin and is formed by injection molding. Preferably, polytubylene terephtalate (PBT) is used for the injection molding of the lead wire holding member 3. PBT is excellent in strength, rigidity, and thermal resistance and is preferably used for injection molding. In addition, PBT is widely available in low cost, and is used extensively as a plastic material. By using PBT, it is possible to manufacture the lead wire holding member 3 at a low cost with desired properties. However, it should be understood that the lead wire holding member 3 may be made of any suitable material other than PBT.

The lead wire holding member 3 includes an abutting portion 31 whose shape is substantially the same as the wire outlet opening 11 when viewed in the axial direction. The lead wire holding member 3 also includes a convex portion 30 which protrudes downwardly from the abutting portion 31. In this preferred embodiment of the present invention, the convex portion 30 is defined by two plate portions arranged in a V-shape and connected at a tip portion of the V-shape. One side thereof, a contact plate 32, elastically presses and holds the lead wires 4. The lead wire holding member 3 is preferably formed by injection molding with PBT, and therefore, the contact plate 32 has an appropriate elasticity. At a bottom end portion of the convex portion 30, two claws 33 are provided, and each of them are arranged on a different side of the convex portion 30 so as to protrude in a different direction from each other. By virtue of this configuration, the lead wire holding member 3 is firmly held in the wire outlet opening 11.

Two notches 34 are provided on the abutting portion 31. Each of the notches 34 is arranged at a position substantially axially above each of the claws 33. Without the notches 34, a direction above the claws 33 are covered with the abutting portion 31, and the lead wire holding member 3 cannot be manufactured with a normal die type. Thus, it is necessary to perform an undercut process, in which a slide core is required in addition to the normal type of dies. As a result, the cost for designing the die increases, and also the dimensional accuracy of the lead wire holding member 3 is decreased. In the present preferred embodiment of the present invention, the notches 34 are provided on the abutting portion 31, and therefore, the lead wire holding member 3 is manufactured with a normal die type. The convex portion 30 has a shape substantially the same as the wire outlet opening 11 so that the convex portion 30 precisely fits into the wire outlet opening 11.

Next, inserting and holding the lead wire holding member 3 in the wire outlet opening 11 will be described in detail. The lead wire holding member 3 is axially inserted into the wire outlet opening 11 with a bottom side thereof on which claws 33 are provided projecting axially downward. In this preferred embodiment of the present invention, the convex portion 30 of the lead wire holding member 3 has a shape substantially the same as that of the wire outlet opening 11, and both of them are asymmetric. By virtue of this configuration, the lead wire holding member 3 is inserted into the wire outlet opening 11 only in a specific manner such that the bottom portion thereof projects axially downward. Upon inserting the lead wire holding member 3 into the wire outlet opening 11, the claws 33 are engaged with the portion of the housing 1 defining the wire outlet opening 11 and the convex portion 30 is inwardly deformed. By inserting the lead wire holding member 3 further, the claws 33 reach the bottom end of the wire outlet opening and the bent convex portion is restored to its original shape (i.e., the claws 33 are latched to the housing 1 around the bottom end of the wire outlet opening 11). The abutting portion 31 abuts against a portion of the housing 1, and the insertion of the lead wire holding member is completed. In this preferred embodiment of the present invention, each of claws 33 is arranged on a different side of the lead wire holding member 3 and protrudes in a different direction from each other. With the claws 33 mentioned above, the lead wire holding member 3 does not come off of the housing 1 even when applying a force in the axial direction thereto.

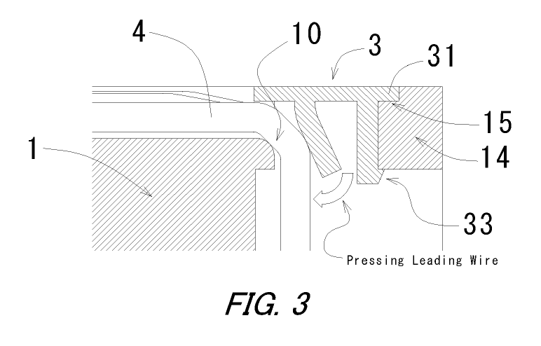

In inserting the lead wire holding member 3 into the wire outlet opening, the contact plate 32 is elastically bent by contacting with the lead wires 4 and presses the lead wires 4 against the edge 10 as shown in FIG. 3. Therefore, the lead wires 4 are pinched between the edge 10 and the contact plate 32 and are firmly held therebetween.

When the lead wires 4 are thick or a great number of lead wires 4 are used, the contact plate 32 is significantly bent. Therefore, a greater pressure is applied from the contact plate 32 to the lead wires 4. When the lead wires 4 are thin or a small number of lead wires 4 are used, the contact plate 32 is slightly bent. Therefore, a smaller pressure is applied from the contact plate 32 to the lead wires 4. The thin lead wires 4 may be broken or damaged when they are pressed by a strong pressure. In the present preferred embodiment of the present invention, however, since the pressure applied to the lead wires 4 is automatically adjusted based on the dimension and/or the number of lead wires, even the thin lead wires 4 are pressed and held without breaking or damaging.

As explained above, since the edge 10 has the curved shape, the lead wires 4 and the covers thereof are not damaged by being pressed against the edge 10. However, it should be understood that the shape of the edge 10 is not limited to the curved shape. It may be any shape as long as it does not damage the wires or the covers of the wires when they are pressed thereto, such as a chamfered shape.

When there is still a concern that the lead wires 4 and/or covers thereof may be broken and/or damaged, the contact plate 32 may be formed so as not to press the lead wires 4 against the edge 10. By inserting the lead wire holding member 3 into the wire outlet opening 11, the lead wires 4 are held in a downwardly bent manner within the wire outlet opening 11. In this case, the lead wires 4 are not pinched by the contact plate 32 and the edge 10, but since the lead wires 4 are bent and held in an L-shape by the abutting portion 31 and the contact plate 32, it is possible to firmly hold the lead wires 4. Therefore, even in the case that an external force is applied to the lead wires 4, the lead wires 4 are not easily moved.

The rib 13a extends in the radially outward direction from the base portion 12, and therefore, the lead wire guiding groove 13a 1 provided on the rib 13a and the lead wires 4 extend in the radially outward direction as well. The edge 10 is defined by the lead wire guiding groove 13a 1 and the wire outlet opening 11 and is formed so that the lead wire guiding groove 13a 1 and the wire outlet opening 11 cross at right angles. In addition, the contact plate 32 provided on the lead wire holding member 3 faces the edge 10 in the radial direction so as to press the lead wires 4 in the radial direction.

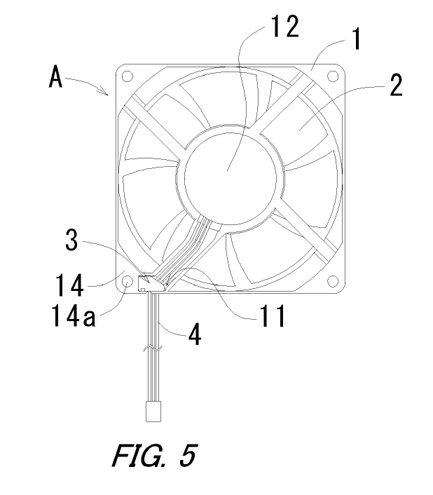

Conventionally, the wire length of each of the lead wires 4 is substantially the same, and when the contact plate 32 presses the lead wires 4 extending from the circuit board against the edge 10 which does not cross the lead wire guiding groove at a right angle (i.e., the contact plate 32 does not press the lead wire in the direction other than that parallel to which the lead wires 4 extend), a wire length of each of the lead wires 4 from the circuit board to a position where the contact plate 32 presses the lead wires 4 is different from each of the other lengths. Wiring such lead wires 4 at an outside of the housing, an external force is intensively applied to the lead wire 4 having the shortest wire length from the edge 10 to a connector pressure welded with the tip ends of the lead wires 4. This may result in breaking or damaging of this lead wire 4. In the present preferred embodiment of the present invention, however, the lead wires 4 are pressed in the radial direction as shown in FIG. 5, which makes the wire length of each of lead wires 4 substantially the same as each other. Therefore, the risk of breaking or damaging lead wires 4 is significantly decreased.

A step portion 15 which houses the abutting portion 31 of the lead wire holding member 3 may be provided around an upper end of the wire outlet opening 11. The step portion 15 is a portion of the housing lat which an upper end surface is axially downwardly recessed. The step portion 15 has a shape substantially the same as that of the abutting portion, and its depth is substantially the same as an axial thickness of the abutting portion 31. By virtue of this configuration, the abutting portion 31 fits within the step portion 15 without protruding axially upwardly. Upon inserting the lead wire holding member 3 into the wire outlet opening 11, the claws 33 are latched to the bottom end of the wire outlet opening 11 and the abutting portion 31 is housed in the step portion 15 around the wire outlet opening 11. Therefore, the axial movement of the lead wire holding member 3 is restricted, and the lead wire holding member 3 does not easily come off of the opening 11a.

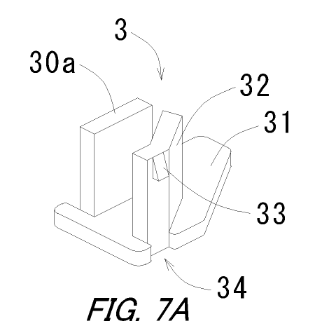

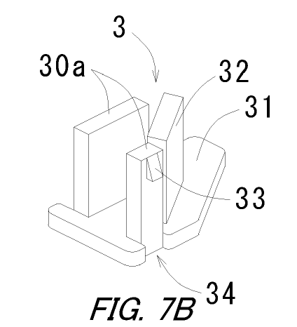

FIGS. 7A and 7B show another preferred embodiment of the present invention. In this preferred embodiment of the present invention, the V-shape convex portion 30 is separated at a tip portion thereof so that the convex portion 30 is divided into two separate portions. As a result, the strength of the contact plate 32 is weakened. The force which the contact plate 32 applies to the lead wires 4 is weakened as well. Therefore, in case that the covers of the lead wires 4 are easily damaged, this preferred embodiment of the present invention is preferably used. In case that it is preferable to further weaken the pressure applied to the lead wires 4, the convex portion 30 may be divided into three or more separate portions as shown in FIG. 7B.

Additionally, the shape of the convex portion 30 is not limited to the V-shape. The convex portion may be any suitable shape as long as it includes the contact plate 32 and the claws 33.

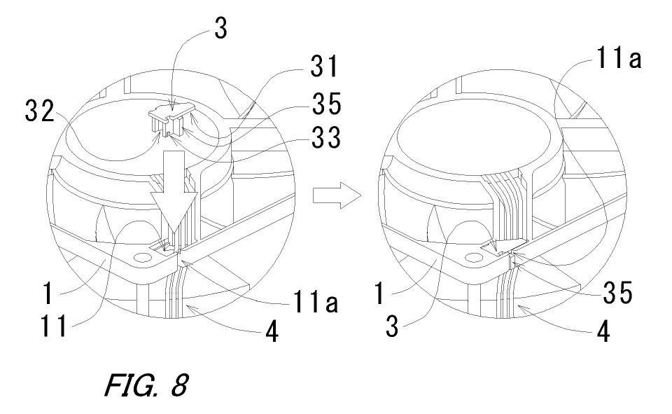

FIG. 8 is a perspective view of the lead wire holding member 3 according to another preferred embodiment of the present invention. In this preferred embodiment of the present invention, the V-shape convex portion 30 further includes a protruding portion 35 which protrudes radially outwardly from the lead wire holding member 3. As shown in FIG. 8, the protruding portion 35 axially extends from the convex portion 30 and is arranged so as to fit into the opening 11a provided on the housing 1. By virtue of this configuration, the lead wire holding member 3 is further properly aligned and is firmly held within the wire holding opening 11.

In this preferred embodiment of the present invention, the claws 33 are arranged on the convex portion 30 to hold the lead wire holding member 3 in the wire outlet opening 11. However, a latching portion other than a claw may be provided on the convex portion 30. For example, the convex portion 30 may include a concave portion which engages with a convex portion arranged on a circumferential wall of the wire outlet opening 11.

### Second Preferred Embodiment

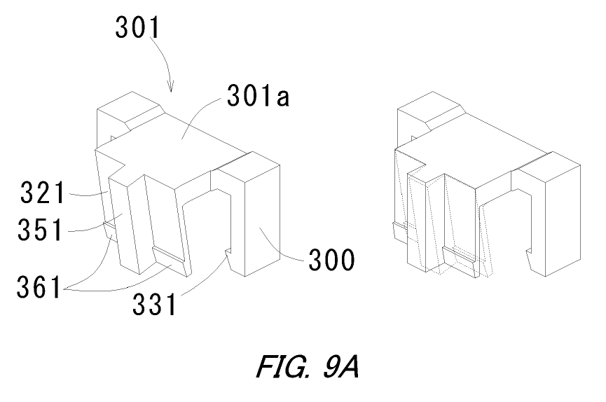

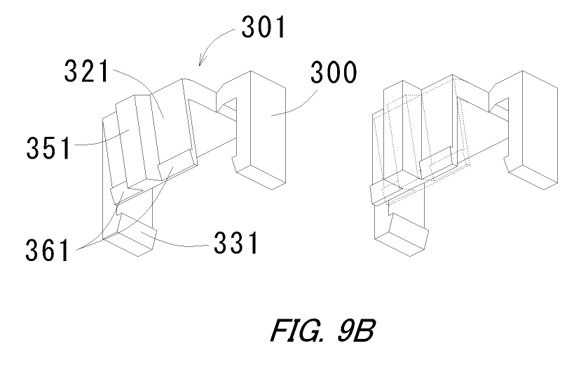

Referring to FIGS. 9 to 12, the second preferred embodiment of the present invention will be described in detail. In FIGS. 9 to 12, the members and the portions which are similar or identical to those explained in the first preferred embodiment are labeled with the same reference numbers in the explanation that follows.

The fan A according to the second preferred embodiment of the present invention includes features which are similar to those described in the first preferred embodiment of the present invention. Therefore, a detailed explanation of such features will be omitted.

In the second preferred embodiment of the present invention, two locking through holes 11b, axially protruding through the flange portion 14, are provided at a position radially inward from the wire outlet opening 11 in a manner that the lead wire guiding groove 13a 1 is sandwiched between the locking through holes 11b. Upon inserting the lead wire holding member 3 into the wire outlet opening 11, a pair of convex portions 300 are inserted into the locking through holes 11b. The step portion 11c is provided on a portion of the housing 1, between the lead wire guiding groove 13a 1 and the locking through holes 11b. The step portion 11C is a portion of the housing 1 where the upper end surface thereof is axially downwardly recessed. The step portion 11c has an appropriate axial depth so that lead wire holding member 301 attached to the housing 1 does not protrude axially upwardly from the upper end surface of the housing 1.

Next, the lead wire holding member 301 will be described in detail.

As shown in FIGS. 9A and 9B, the lead wire holding member 301 includes a pair of convex portions 300 which are parallel to each other. One end of each of the convex portions 300 is connected to a base 301a, corresponding to the abutting portion 31 shown in the first preferred embodiment of the present invention. A claw 331 is arranged at a bottom end of each of the convex portions 300, and the claw 331 of each of the convex portions 300 faces the other. The lead wire holding member 301 includes a contact plate 321 extending downwardly from the base 301a and pressing the lead wires 4 against the edge 10 upon the insertion thereof into the wire outlet opening 11. The lead wire holding member 301 also includes a protruding portion 351 which protrudes radially outwardly from the contact plate 321. The protruding portion 351 axially extends on an outside surface of the contact plate 321 and fits into the opening 11a provided on the housing 1. In addition, claws 361 are arranged on a bottom end portion of the outside surface of the contact plate 321.

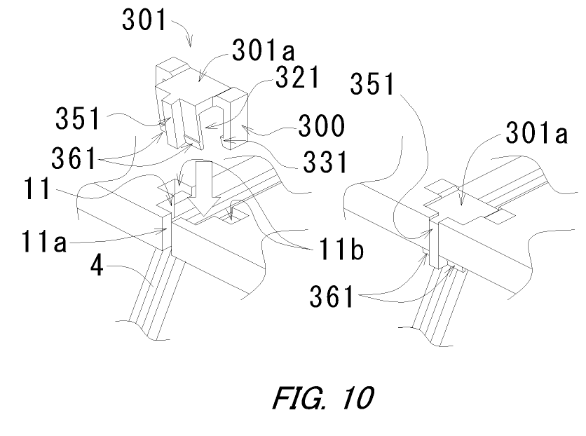

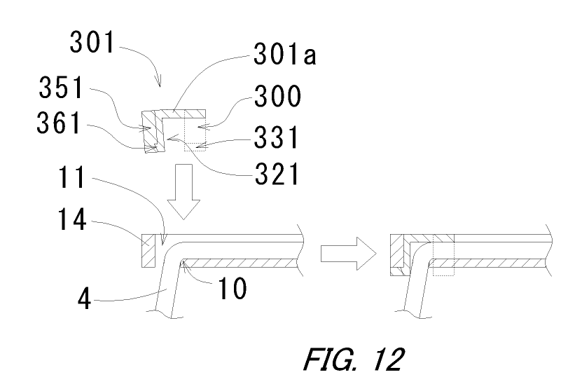

As shown in FIG. 10, upon the insertion of the lead wire holding member 301, the contact plate 321 is inserted into the lead wire outlet opening 11, and the convex portions 300 are inserted into the locking through holes 11b. Furthermore, the projecting portion 351 fits into the opening 11a. In the beginning of the insertion, the claws 331 engage with the lead wire guiding groove 13a1, and therefore, the convex portions 300 are stretched out. By continuing to insert the lead wire holding member 301, the claws 331 reach bottom ends of the locking through holes 11b and are latched to the housing 1. During the insertion, the contact plate 321 also contacts with the lead wires 4 and is elastically bent. Then, as shown in FIG. 12, the claws 361 are latched to a portion of the housing 1 defining the bottom end of the lead wire outlet opening 11. At the same time, the lead wires 4 are pressed against the housing 1 by the contact plate 321 and are held within the wire outlet opening 11. Moreover, since the edge 10 defined by the lead wire outlet opening 11 and the lead wire guiding groove 13a 1 has a curved shape, the lead wires 4 and the covers thereof are not easily damaged when the lead wires 4 are pressed against the edge 10 by the contact plate 321. The lead wire holding member 301 is preferably formed by injection molding with PBT, and therefore, the contact plate 321 has an appropriate elasticity.

In order to press the lead wires 4 with the predetermined pressure, the contact plate 321 may be arranged in a manner inclined 0 to 10 degrees from the insertion direction. With the predetermined pressure applied by the contact plate 321, the lead wires 4 are held without breaking and/or damaging. As shown in FIGS. 9A and 9B, the contact plate 321 is elastically deformed from the shape shown by the broken line to that shown by the solid line during the insertion of the lead wire holding member 3. When the incline of the convex portion 321 is 0 degrees, a smaller pressure is applied to the lead wires 4. When the incline of the convex portion 321 is 10 degrees, a greater pressure is applied to the lead wires 4. The angle of inclination may be determined based on the dimensions and/or types of the lead wires 4.

When the lead wires 4 are thick and/or a great number of lead wires 4 are used, the contact plate 321 is significantly bent. Therefore, the greater pressure is applied by the contact plate 321 to the lead wires 4. When the lead wires 4 are thin and/or a small number of lead wires 4 are used, the contact plate 32 is slightly bent. Therefore, the smaller pressure is applied by the contact plate 321 to the lead wires 4. The thin lead wires 4 may be broken or damaged when they are pressed against the edge 10 with great pressure. In the present preferred embodiment of the present invention, however, since the pressure applied to the lead wires 4 is automatically adjusted based on the dimension and/or the number of lead wires, even the thin lead wires 4 are pressed and held without breaking or damaging. In other words, the lead wire holding member 301 according to the present preferred embodiment of the present invention can firmly hold the lead wires without damaging the wires regardless of the dimensions and number of wires.

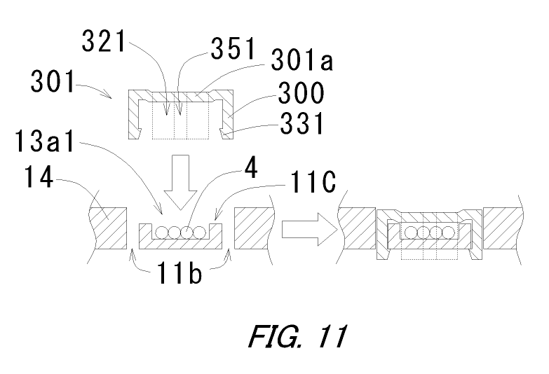

As shown in FIG. 11, the claws 331 provided on the tip end of the convex portions 300 are latched on the portion of the housing 1 defining the bottom side of the locking through holes 11b. In addition, as shown in FIG. 12, the claws 361 provided on the contact plate 321 are latched on the portion of the housing 1 defining the bottom end of the wire outlet opening 11. With the claws 331 and 361 latched to the housing 1, the lead wire holding member 3 does not come off of the housing 1 when an external force in the axial direction is applied thereto.

When there is a concern that the lead wires 4 and/or the covers thereof may be broken and/or damaged, the contact plate 32 may be formed so as not to press the lead wires 4 against the edge 10. By attaching the lead wire holding member 3 according to another preferred embodiment of the present invention, the lead wires 4 are held in a downwardly bent manner within the lead wire outlet opening 11. In this case, the lead wires 4 are not pinched by the contact plate 32 and the edge 10, but since the lead wires 4 are held in a bent L-shape by the abutting portion 31 and the contact plate 32, it is possible to firmly hold the lead wires 4.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A fan comprising:
a motor;
an impeller mounted to the motor and generating air flow by rotation around a rotation axis thereof;
a housing defining a passage of the air flow and arranged to support the motor;
a wire outlet opening provided on the housing in a manner axially penetrating the housing;
at least one wire arranged to supply electricity from an external power supply to the motor and to extend into the wire outlet opening from an upper end thereof and extend out of the wire outlet opening from a bottom end thereof; and
a wire holding member inserted into the wire outlet opening which the at least one wire passes through, the wire holding member including an abutting portion abutting against a portion of the housing near the upper end of the wire outlet opening, a plate portion protruding from the abutting portion and guiding the at least one wire toward the bottom end of the wire outlet opening, and a latching portion arranged to latch to a portion of the housing; wherein
the wire holding member is arranged to be inserted into the wire outlet opening from an upper direction after the at least one wire is inserted therein, and a movement of the wire holding member into the wire outlet opening is restricted by the latching portion latching to the portion of the housing and the abutting portion abutting against the portion of the housing near the upper end of the wire outlet opening.

2. The fan as set forth in claim 1, wherein the latching portion is latched to a portion of the housing defining the bottom end of the wire outlet opening.

3. The fan as set forth in claim 2, wherein the latching portion of the wire holding member includes at least two convex or concave portions arranged to be latched to the portion of the housing defining the bottom end of the wire outlet opening, each of the convex or concave portions extending in different directions.

4. The fan as set forth in claim 2, wherein the plate portion of the wire holding member inserted into the wire outlet opening faces toward a portion of the housing near the upper end of the wire outlet opening in a radial direction of the fan.

5. The fan as set forth in claim 4, wherein the at least one wire is elastically pressed against the housing by the plate portion of the wire holding member inserted into the wire outlet opening, and is pinched by the plate portion and another portion of the housing near the upper end of the wire outlet opening.

6. The fan as set forth in claim 2, further comprising an opening extending radially from the wire outlet opening to an outside of the housing, wherein the at least one wire is inserted into the wire outlet opening from the outside of the housing via the opening, and the plate portion of the wire holding member includes a protruding portion protruding radially outwardly therefrom and fit into the opening.

7. The fan as set forth in claim 1, wherein the housing further includes a through hole near the wire outlet opening, and the latching portion is latched to a portion of the housing defining a bottom end of the through hole.

8. The fan as set forth in claim 7, wherein the latching portion of the wire holding member includes at least two convex or concave portions arranged to be latched to the portion of the housing defining the bottom end of the wire outlet opening, each of the convex or concave portions extending in different directions.

9. The fan as set forth in claim 8, wherein the plate portion includes a locking portion arranged to be latched to another portion of the housing defining the bottom end of the wire outlet opening.

10. The fan as set forth in claim 7, wherein the plate portion of the wire holding member inserted into the wire outlet opening faces toward a portion of the housing near the upper end of the wire outlet opening in a radial direction of the fan.

11. The fan as set forth in claim 10, wherein the at least one wire is elastically pressed against the housing by the plate portion of the wire holding member inserted into the wire outlet opening, and is pinched by the plate portion and the portion of the housing near the upper end of the wire outlet opening.

12. The fan as set forth in claim 7, further comprising an opening radially extending from the wire outlet opening to an outside of the housing, wherein the at least one wire is inserted into the wire outlet opening from the outside of the housing via the opening, and the plate portion of the wire holding member includes a protruding portion protruding radially outwardly therefrom and fit into the opening.

13. The fan as set forth in claim 1, wherein a direction in which the plate portion protrudes is substantially the same as a direction into which the wire holding member is inserted into the wire outlet opening.

14. The fan as set forth in claim 13, wherein the plate portion of the wire holding member inserted into the wire outlet opening faces toward a portion of the housing near the upper end of the wire outlet opening in a radial direction of the fan.

15. The fan as set forth in claim 1, further comprising an opening extending radially from the wire outlet opening to an outside of the housing, wherein the at least one wire is inserted into the wire outlet opening from the outside of the housing via the opening, and the plate portion of the wire holding member includes a protruding portion protruding radially outwardly therefrom and fit into the opening.

16. The fan as set forth in claim 1, further comprising a step portion near the upper end of the wire outlet opening, the abutting portion is placed in the step portion without protruding axially upwardly from an upper end surface of the portion of the housing near the step portion.

17. The fan as set forth in claim 1, wherein the wire holding member is made of a molded plastic or resin.

18. The fan as set forth in claim 1, wherein the latching portion of the wire holding member includes at least two convex or concave portions arranged to be latched to the portion of the housing defining the bottom end of the wire outlet opening, each of the convex or concave portions extending in different directions.

19. The fan as set force in claim 1, wherein the portion of the housing near the upper end of the wire outlet opening and contacting with the at least one wire has a curved shape or a chamfered shape.

20. The fan as set forth in claim 1, wherein the at least one wire is elastically pressed against the housing by the plate portion of the wire holding member inserted into the wire outlet opening, and is pinched by the plate portion and another portion of the housing near the upper end of the wire outlet opening.

21. The fan as set forth in claim 1, wherein the plate portion of the wire holding member inserted into the wire outlet opening faces toward a portion of the housing near the upper end of the wire outlet opening in a radial direction of the fan.
